(19) United States
(12) Patent Application Publication
(10) Pub. No.: US 2012/0070800 A1
(43) Pub. Date: Mar. 22, 2012

(54) Dental Drill Bit

(76) Inventors: Serim Kayacan Ilday, Ankara (TR); Nilay Er, Kayseri (TR); Alper Alkan, Kayseri (TR); Erman Bengü, Ankara (TR)

(21) Appl. No.: 13/236,580

(22) Filed: Sep. 19, 2011

Related U.S. Application Data
(60) Provisional application No. 61/384,330, filed on Sep. 20, 2010.

(51) Int. Cl. A61C 3/02

(52) U.S. Cl. 433/165

(57) ABSTRACT

The present invention relates to a dental drill bit, covered by a multilayered protective coating, comprising at least one substrate (2) which is made of durable metal, at least one metal coating (3) which is placed on the substrate (2), at least one ceramic coating (4) which is placed on the metal coating (3), and at least one protective coating (5) which is placed on the ceramic coating (4).

### CROSS-REFERENCE TO RELATED APPLICATION

This application claims priority under 35 U.S.C. §119(e) to U.S. Provisional Application No. 61/384,330, filed Sep. 20, 2010, and which is hereby incorporated by reference for all purposes.

### BACKGROUND

1. Field of Invention

The present invention relates to a dental drill covered by a multilayered and protective coating.

2. Background of Invention

Modification and control of surface properties with coatings is a highly desired, broadly used process mostly in the automotive, aerospace and heavy industries. There are a number of studies on protective, heat and wear resistant coating applications for the aforementioned industries. Considering the growing demand of the medical industry, it is surprising that there are few reports on the application of these coatings onto medical tools. Possible explanations for this might be the difficulties regarding the development and implementation of a suitable coating, adhesion of the coating to the substrate, and its biocompatibility.

Dental implants are inorganic materials used in lieu of missing teeth to fill the void in the alveolar bone. The implants are placed into a slot, which is drilled in the alveolar bone. Three types of commercial dental drill bit materials are commonly used, namely, stainless steel, zirconium, and black diamond. Among these, stainless steel is the most widely used due to its longer lifetime of approximately 25 drill runs, when assisted with external or internal water cooling.

During the drilling process, the bone temperature increases due to friction between the bone and the dental drill and the most common problem is the high risk of bone tissue necrosis which occurs if the bone temperature exceeds 47° C. for 1 minute or longer. The drawbacks include inhibition of the merger of the implant to the bone (osseointegration).

Prior art exists where researchers sought to overcome this problem by optimizing drill bit geometry and/or process variables, but only limited improvement has been reported. On the other hand, modification of the surface properties through the use of protective coatings is a promising technique, offering high performance as well as ease of use. While protective coatings are broadly used in various industrial applications, there are few reports on the application of these techniques to medical tools.

The U.S. patent document numbered U.S. Pat. No. 4,642,271 discloses a ceramic fiber composite material comprised of boron nitride coated ceramic fibers embedded in a ceramic matrix. The boron nitride coating maintains high coherence to the fibers, thereby limiting bonding and chemical reactions between the fibers and the ceramic matrix, so that excellent strength and toughness characteristics may be realized. The boron nitride coating remains stable at temperatures far higher than the melting point of metal coatings so that the superior strength and toughness characteristics are retained in high temperature process and use environments.

### SUMMARY OF THE INVENTION

The object of the invention is to provide a dental drill bit, which has a protective and wear-resistant BN coating on stainless steel.

A further object of the invention is to provide a dental drill bit, which is coated by metal and ceramic coatings, increasing adhesion force between two layers.

A further object of the invention is to provide a dental drill bit, which has a multilayered, protective coating.

A further object of the invention is to provide a dental drill bit, which decrease the alveolar bone temperature increase compared to the commonly used stainless steel drill bits during the drilling process.

A further object of the invention is to provide a dental drill bit, which has a longer lifetime and improved performance than the uncoated stainless steel drill bits.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 shows a cross-sectional view of a dental drill bit, according to an embodiment of the present invention.

FIG. 2 shows a graphic which compares the experimental results of temperature variations on the bovine femoral cortical bone after 50 uncooled drill runs using uncoated stainless steel and BN-coated stainless steel dental drill bits.

FIG. 3 shows a graphic, which presents the measured temperature variations of the bovine femoral cortical bone after 1st, 25th, and 50th water-assisted cooling drilling using un-coated stainless steel dental drill bits.

FIG. 4 shows a graphic, which presents the measured temperature variations on the bovine femoral cortical bone after 1st, 25th, and 50th water-assisted cooling drilling using BN-coated stainless steel dental drill bits.

### DETAILED DESCRIPTION OF SPECIFIC EMBODIMENTS

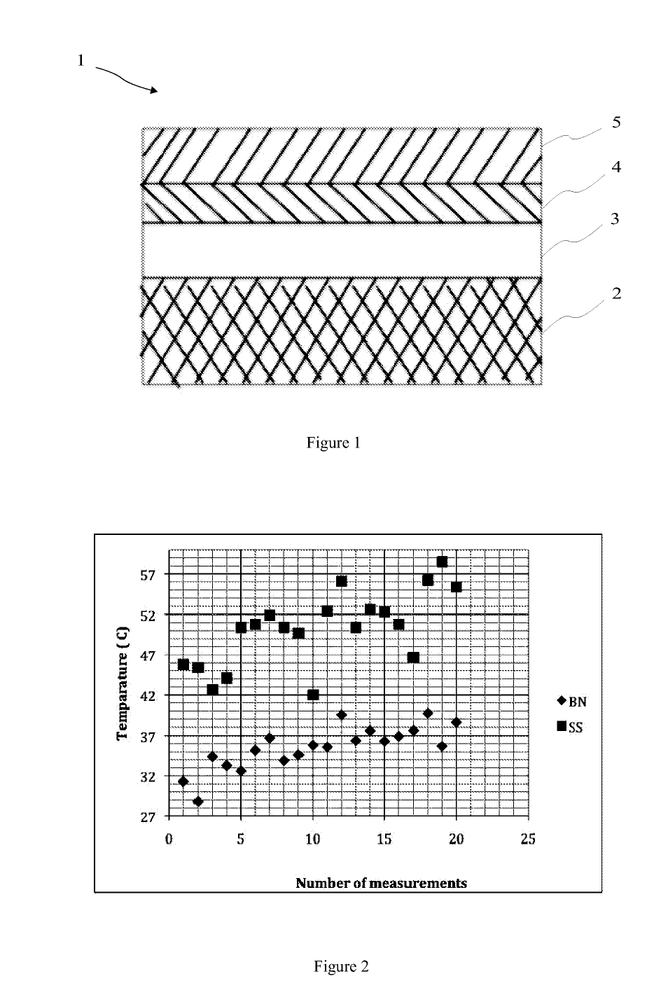

Elements shown in FIG. 1 are numbered as follows:

1 Dental drill bit

2 Substrate

3 Metal coating

4 Ceramic coating

5 Protective coating

A dental drill bit (1) comprises at least one substrate (2), which is made of durable metal, at least one metal coating (3), which is placed on the substrate (2), at least one ceramic coating (4), which is placed on the metal coating (3), at least one protective coating (5), which is placed on the ceramic coating (4).

The substrate (2) is the main material, which is used to form the dental drill bit (1). In a preferred embodiment of the invention, substrate (2) is made of stainless steel.

The metal coating (3) is the material, coated onto the substrate (2), which is biocompatible, adhesive and which acts as an interface medium between the substrate (2) and the ceramic coating (4). In the preferred embodiment of the invention, the metal coating (3) is made of at least one of the transition metals such as Fe, Ti, Cr, and Ni.

The ceramic coating (4) is the material, coated on the metal coating (3), which is biocompatible, adhesive and which acts as an interface medium between the metal coating (3) and the protective coating (5). In the preferred embodiment of the invention, the ceramic coating (4) is made of nitride ceramic.

The protective coating (5) is a material, coated on the ceramic coating (4) by using a physical vapour deposition (PVD) technique, which increases wear and heat resistance of the whole dental drill bit (1). In the preferred embodiment of the invention, the protective coating (5) is made of boronitride (BN), which brings a low coefficient of friction and high hardness to the dental drill bit (1).

In embodiments of the present invention, the protective coating (5) is first optimized by deposition onto stainless steel disk shaped substrates (2). The characterization of the material properties is made through X-ray diffraction (XRD), Raman, and Fourier transform infrared (FTIR) spectroscopies, and nanoindentation measurements.

First, the crystal structure of the synthesized coatings is investigated using XRD, Raman, and FTIR spectroscopies. Results show that the structure highly consists of rhombohedral phase and some cubic, wurtzitic, and hexagonal phases also exist.

Second, nano-indentation tests are performed to assess the hardness of the coatings. Since the topmost BN coating (5) has a nanometer range thickness, a nanoindentor is used instead of a microindentor. Results have shown that the hardness of the optimized BN coating is as much as 36 GPa while for stainless steel; the hardness is between 2-5 GPa.

Lastly, the optimized coating is applied onto 20 dental drill bits and tested in conditions mimicking the actual use and statistical information is derived from the performance of these bits. For these tests, bovine femoral cortical bone is used due to its similar density to that of the human mandible alveolar bone. Bone temperature is monitored using two thermocouples each placed 1 mm next to the drilled cavity and the depth of the thermocouples are 4 mm and 8 mm, respectively. A setup based on a parallelometer has been used to test the coated bits. A dental surgical motor is used to drill 10 mm deep slots into the bone attached to the parallelometer. The working speed is set to 2000 rpm. The drilling process is set as 1 minute and a load of 2 kg is applied to the parallelometer. Temperature changes are monitored during the drilling and the maximum temperature readings are recorded for the 1st, 25th, and 50th usages of each of the 20 bits. 10 bits are tested for water-assisted drilling operation and 10 bits are tested for uncooled drilling operation. Under both conditions, a drilling process is performed with internal irrigation of physiological saline solution in order to better mimic realistic conditions. After every drilling process, the bits are sterilized using an autoclave at 134° C. for 70 minutes, which is the standard clinical practice.

Finally, commercially obtained dental bits made of stainless steel, black diamond and zirconium are also subjected to the same tests, under the identical conditions, as control experiment. Results show that the bone temperature in BN-coated dental drill bits does not exceeded the necrosis limit even in uncooled operation and after 50 usages (FIG. 2), which is remarkable in its own right. The maximum temperature reached is 33.7° C. with the BN-coated drill bits. This is in stark contrast to the results obtained using commercial bits. Temperatures as high as 54° C., 83.2° C. and 82.1° C. are reached with uncoated stainless steel, black diamond and zirconium bits, respectively, under the identical conditions. It is also noted that the maximum bone temperature did not vary appreciably between 25 usages and 50 usages for the BN-coated bits during uncooled operation.

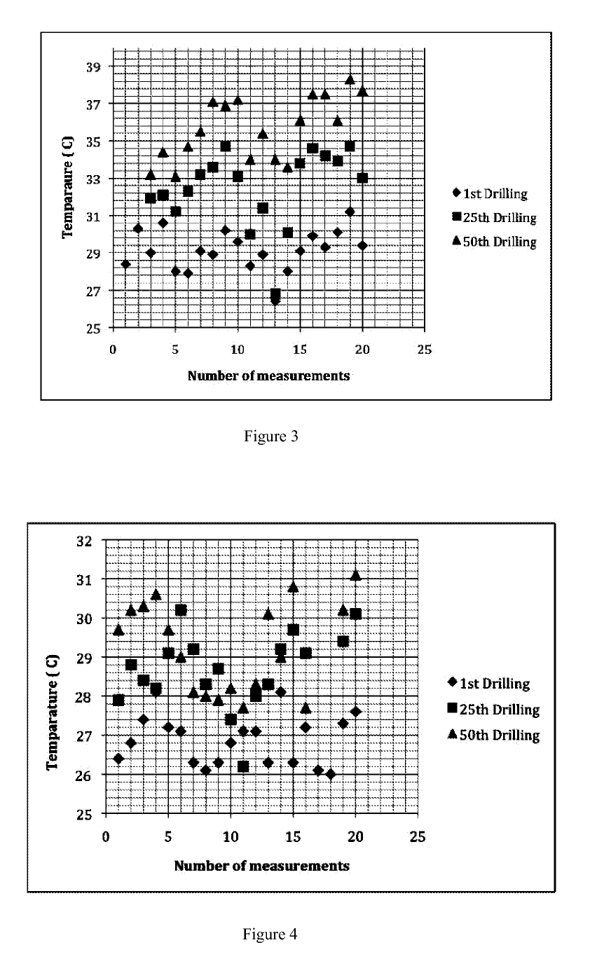

In contrast, commercial bits show dramatic changes between 25 usages and 50 usages. With water-cooling, the maximum bone temperature reached after the 1st, 25th, and 50th usages are 28.1° C., 30.2° C., and 31.1° C., respectively for the BN-coated bits and 31.2° C., 34.7° C., and 38.3° C., respectively for the uncoated bits (FIGS. 3 and 4). The initial bone temperature for these measurements is around 23-24° C., whereas the nominal bone temperature for the alveolar bone is 36° C., i.e., the nominal human body temperature. Therefore, in actual clinical practice, the final temperatures are expected to be 12-13° C. higher than the maximum temperature values reported here. In other words, the BN-coated bits are expected to remain below the 47° C. level at all times, whereas the uncoated bits are expected to reach this limit as early as after 25 usages.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

We claim:

1. A dental drill bit comprising:
at least one substrate, which is made of durable metal;
at least one metal coating, which is placed on the substrate;
at least one ceramic coating, which is placed on the metal coating;
at least one protective coating, which is placed on the ceramic coating; and characterized by,
the metal coating, coated on the substrate, which is a biocompatible adhesive and which acts as an interface medium between the substrate and the ceramic coating;
the ceramic coating, coated on the metal coating, which is a biocompatible adhesive and which acts as an interface medium between the metal coating and the protective coating; and
the protective coating made of boronitride (BN) which provides a low coefficient of friction and high hardness to the dental drill bit.

2. A dental drill bit according to claim 1, wherein the substrate is the main material used to form the dental drill bit.

3. A dental drill bit according to claim 1, wherein the substrate is made of stainless steel.

4. A dental drill bit according to claim 2, wherein the substrate is made of stainless steel.

5. A dental drill bit according to claim 1, wherein the metal coating is made of at least one of the transition metals selected from the group consisting of Fe, Ti, Cr, and Ni.

6. A dental drill bit according to claim 2, wherein the metal coating is made of at least one of the transition metals selected from the group consisting of Fe, Ti, Cr, and Ni.

7. A dental drill bit according to claim 3, wherein the metal coating is made of at least one of the transition metals selected from the group consisting of Fe, Ti, Cr, and Ni.

8. A dental drill bit according to claim 4, wherein the metal coating is made of at least one of the transition metals selected from the group consisting of Fe, Ti, Cr, and Ni.

9. A dental drill bit according to claim 1, wherein the ceramic coating is made of nitride ceramic.

10. A dental drill bit according to claim 2, wherein the ceramic coating is made of nitride ceramic.

11. A dental drill bit according to claim 3, wherein the ceramic coating is made of nitride ceramic.

12. A dental drill bit according to claim 4, wherein the ceramic coating is made of nitride ceramic.

13. A dental drill bit according to claim 5, wherein the ceramic coating is made of nitride ceramic.

14. A dental drill bit according to claim 6, wherein the ceramic coating is made of nitride ceramic.

15. A dental drill bit according to claim 7, wherein the ceramic coating is made of nitride ceramic.

16. A dental drill bit according to claim 1, wherein the protective coating increases wear and heat resistance of the whole dental drill bit.

17. A dental drill bit according to claim 2, wherein the protective coating increases wear and heat resistance of the whole dental drill bit.

18. A dental drill bit according to claim 3, wherein the protective coating increases wear and heat resistance of the whole dental drill bit.

19. A dental drill bit according to claim 5, wherein the protective coating increases wear and heat resistance of the whole dental drill bit.

20. A dental drill bit according to claim 9, wherein the protective coating increases wear and heat resistance of the whole dental drill bit.
